(19) United States
(12) Patent Application Publication
(10) Pub. No.: US 2013/0213318 A1
(43) Pub. Date: Aug. 22, 2013

(54) Animal Handling Station

(71) Applicant: PetEdge, Inc., (US)

(72) Inventor: Andrew S. Katz, Beverly, MA (US)

(73) Assignee: PETEDGE, INC., Beverly, MA (US)

(21) Appl. No.: 13/842,357

(22) Filed: Mar. 15, 2013

Related U.S. Application Data
(63) Continuation-in-part of application No. 12/833,602, filed on Jul. 9, 2010.

(51) Int. Cl. A01K 13/00

(52) U.S. Cl. CPC A01K 13/001
USPC 119/754

(57) ABSTRACT

Exemplary embodiments provide an animal hander station configured for use in handling an animal. The handling station can be a grooming tub having base work platform and a wall extending perpendicularly from a perimeter of the base work platform. The grooming tub can be designed and configured to have a dog-bone shaped outline.

### RELATED APPLICATIONS

This application is a continuation-in-part of U.S. patent application Ser. No. 12/833,602 filed on Jul. 9, 2010, the disclosure of which is incorporated by reference herein in its entirety.

### TECHNICAL FIELD

Exemplary embodiments relate generally to stations used in handling and/or bathing animals.

### SUMMARY

Exemplary embodiments provide an ergonomic base work platform attachable to a base unit. The base work platform and the base unit may be configured as an animal handling station, e.g., an animal grooming station, an animal bathing station, an animal examination station, an animal surgery station, and similar platforms for performing animal handling activities.

Exemplary embodiments also provide an ergonomic animal handling station configured for use in handling an animal. The handling station includes a base work platform, a base unit coupled thereto to support the animal, and a handling arm with a handling loop that secures the animal during a handling session.

In an exemplary embodiment, an animal grooming tub including a base work platform and a wall is disclosed. The base work platform forms a closed end of the grooming tub and defines a work surface. The wall extends perpendicularly from a perimeter of the base work platform to define an open end of the grooming tub. The wall includes a first end wall portion, a second end wall, and two opposing middle wall portions. An inner surface of the wall and the work surface of the base work platform define an interior tub area having a first end, a second end, and a middle portion. The first end of the interior tub area being defined by the first end wall portion and having a first width (W1). The second end of the interior tub area being defined by the second end wall portion and having a second width (W2). The middle portion of the interior tub area being defined by the two opposing middle wall portions and having a third width (W3). An animal handler area is formed by the first end wall portion, the second end wall portion and a first one of the two opposing middle wall portions. The animal handler area is defined by a W₃:W₁ ratio of about 1:2 and a W₃:W₂ ratio of about 1:2 to allow an animal handler to be adjacent to an animal disposed within the interior area.

In another embodiment, an animal grooming tub including a base work platform and a wall is disclosed in which the base work platform forms a bottom of the grooming tub and the wall extends from a perimeter of the base platform. The wall has a first side wall portion, a second side wall portion, a first end wall portion, and a second end wall portion. The first side wall portion is opposingly spaced from the second side wall portion. The first end wall portion is opposingly spaced from the second end wall portion. The wall and the base work platform define an interior area of the grooming tub. An animal handler area is defined by a width of the interior area between the first and second side wall portions and a length of the interior area between the first and second end wall portions. The grooming tub also includes at least one cove area that is formed at the first end wall portion. The at least one cove area is defined by an area outside of and adjacent to the animal handler area. The base work platform and the wall have a dog-bone shaped outline.

### BRIEF DESCRIPTION OF THE DRAWINGS

The foregoing and other objects, aspects, features, and advantages of exemplary embodiments will become more apparent and may be better understood by referring to the following description taken in conjunction with the accompanying drawings, in which:

FIG. 1 illustrates a top plan view of an exemplary base work platform configured in a dog-bone shape.

FIG. 2 illustrates a partial top plan view of an exemplary base work platform in which the side walls of the mid-portion are configured to be curved.

FIGS. 3A and 3B illustrate partial top plan views of exemplary base work platforms in which one side wall of the mid-portion is configured to be curved, and the other side wall of the mid-portion is configured to be straight.

FIG. 4 illustrates a partial top view of an exemplary base work platform in which each of the side walls of the mid-portion is configured as a straight portion with a radial cutout.

FIG. 5 illustrates a partial top plan view of an exemplary base work platform in which each of the end portions is configured to have a elliptical shape.

FIG. 6 illustrates a partial top plan view of an exemplary base work platform in which each of the end portions is configured to have a rectangular shape.

FIG. 7 illustrates an exemplary handling station including the exemplary base work platform of FIG. 1, in which the base unit employs an electric lift mechanism.

FIG. 8 illustrates a perspective view of another exemplary animal handling station including the exemplary base work platform of FIG. 1, in which the base unit employs a hydraulic lift mechanism.

FIG. 9 illustrates a perspective view of another exemplary animal handling station including the exemplary base work platform of FIG. 1, in which the base unit employs a set of folding legs.

FIG. 10 is a top view of another exemplary embodiment of an animal handling station configured as an animal grooming tub.

FIG. 11 is a perspective view of the animal handling station of FIG. 10 with a back splash.

FIG. 12 is a more detailed view of a bin illustrated in the animal handling station of FIGS. 10-1.

FIG. 13 is a perspective view of the animal handling station depicted in FIG. 11 with the back splash folded down to form a grooming table.

### DETAILED DESCRIPTION

Exemplary embodiments provide an ergonomic an animal handling station, e.g., an animal grooming station, an animal bathing station, an animal examination station, an animal surgery station, and similar stations for performing animal handling activities. Exemplary embodiments of the animal handling station can include a base work platform, a base unit coupled thereto to support the animal during a handling session. In some exemplary embodiments, the animal handling station can include a tub surround wall or walls extending from the base work platform and the base unit can be configured as a lift mechanism with an adjustable height that supports, lifts and lowers the base work platform or can be configured as a stationary support with a fixed height.

An “animal handling work surface” or “work surface,” as used herein, is a surface on which an animal is supported during a handling session. In exemplary embodiments, the work surface can be the base of an animal groom tub (e.g., an upper surface of the base work platform) and/or a covered used to close the tub to form an upper surface of the base work platform). The animal may be any type of animal including, but not limited to, domestic animals such as cats and dogs.

“Animal handling,” as used herein, may include, but is not limited to, animal grooming, animal bathing, animal medical examination, animal surgical procedures, animal feeding, and similar animal handling activities. An “animal handling session” may include, but is not limited to, animal grooming, animal bathing, animal medical examination, animal surgical procedures, animal feeding, or any combination of such activities.

An “animal handler,” as used herein, is a person who performs an animal handling activity, e.g., a groomer, a veterinarian, a veterinarian technician, a person charged with feeding or bathing the animal, and persons performing similar animal handling activities.

The term “planar” is used herein, in a broad lay sense, to mean exactly planar or approximately planar within some tolerance from the exactly planar.

The term “concave” is used herein, in a broad lay sense, to mean exactly concave or approximately concave within some tolerance from the exactly concave.

The term “convex” is used herein, in a broad lay sense, to mean exactly convex or approximately convex within some tolerance from the exactly convex.

The term “elliptical” is used herein, in a broad lay sense, to mean exactly elliptical or approximately elliptical within some tolerance from the exactly elliptical.

The term “rectangular” is used herein, in a broad lay sense, to mean exactly rectangular or approximately rectangular within some tolerance from the exactly rectangular.

The term “parallel” is used herein, in a broad lay sense, to mean exactly parallel or approximately parallel within some tolerance from the exactly parallel.

The term “straight” is used herein, in a broad lay sense, to mean exactly straight or approximately straight within some tolerance from the exactly straight.

The term “equal” is used herein, in a broad lay sense, to mean exactly equal or approximately equal within some tolerance.

The term “adjacent” is used herein, in a broad lay sense, to mean immediately adjacent or approximately adjacent within some tolerance.

The term “dog-bone shape” is used herein, in a broad lay sense, to mean an exact dog-bone shape or an approximate dog-bone shape within some tolerance.

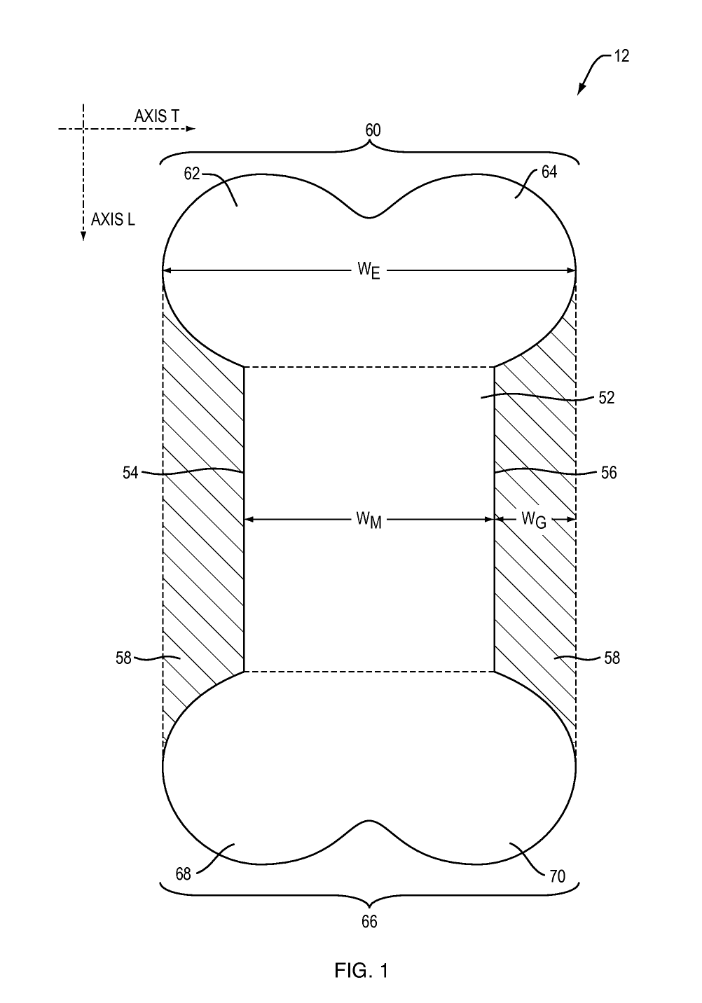

FIG. 1 illustrates a top plan view of an exemplary base work platform 12 configured to support an animal during a handling session. FIG. 1 indicates a longitudinal axis L that runs substantially along the length of the base work platform 12, and a traverse axis T that runs perpendicular to the longitudinal axis L. The base work platform 12 includes a mid-portion 52 disposed contiguously between a first end-portion 60 and a second end-portion 66 along the longitudinal axis L. The mid-portion 52, the first end-portion 60 and the second end-portion 66 cooperatively form a planar surface for supporting the animal. The length of the base work platform 12 measured relative to the longitudinal axis L may range from about 15 inches to about 100 inches.

The mid-portion 52 of the base work platform 12 may be configured to have various shapes. In an exemplary embodiment in which the base work platform 12 is in the shape of a dog bone (as illustrated in FIG. 1), the mid-portion 52 has a rectangular shape, with sides 54, 56 of the mid-portion 52 aligned parallel to the longitudinal axis L. The mid-portion 52 may have a width W_{M} ranging from about 12 inches to about 40 inches at its narrowest portion, as measured relative to the transverse axis T.

In this exemplary embodiment, each end-portion 60, 66 is formed of two contiguous convex portions, e.g., portions that are gibbous shaped (i.e., bulging outwardly away from a center portion of the base work platform). The first end-portion 60 is formed of contiguous gibbous shaped portions 62, 64, and the second end-portion 66 is formed of contiguous gibbous shaped portions 68, 70. The construction and configuration of each end-portion 60, 66 with two gibbous shaped portions 62, 64 and 68, 70, respectively, gives the overall base work platform 12 a dog-bone shaped outline.

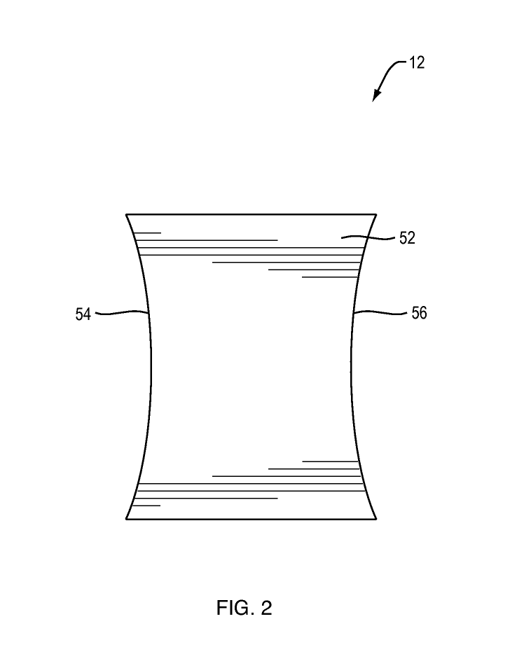

In other exemplary embodiments (as illustrated in FIG. 2), the mid-portion 52 may be formed of two curved sides 54, 56, for example, concave or arched inwardly along the longitudinal axis L toward a center portion of the base work platform 12.

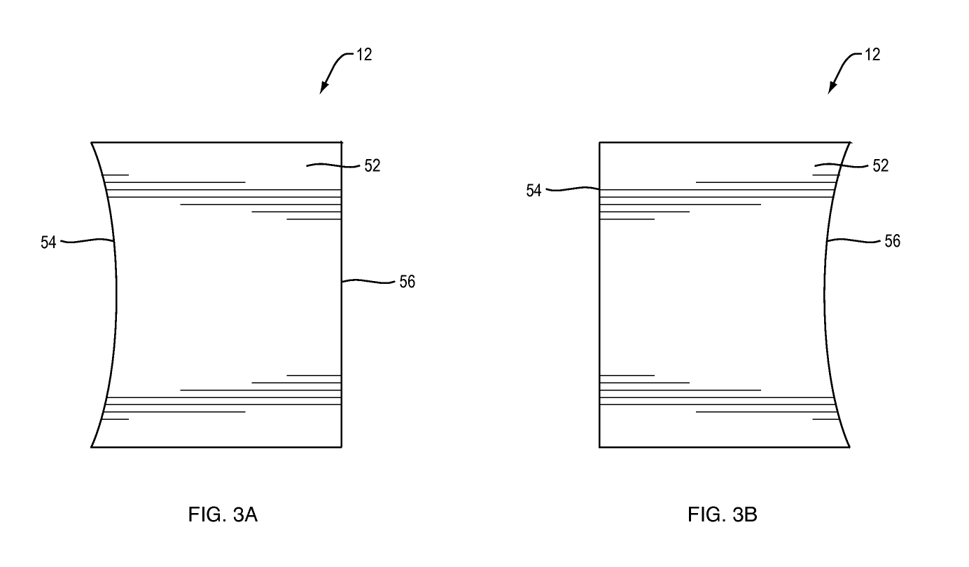

In other exemplary embodiments (as illustrated in FIGS. 3A and 3B), one of the sides 54, 56 of the mid-portion 52 may be straight and aligned parallel to the longitudinal axis L, and the other of the sides 54, 56 may be curved, for example, concave or arched inwardly along the longitudinal axis L toward a center portion of the base work platform 12.

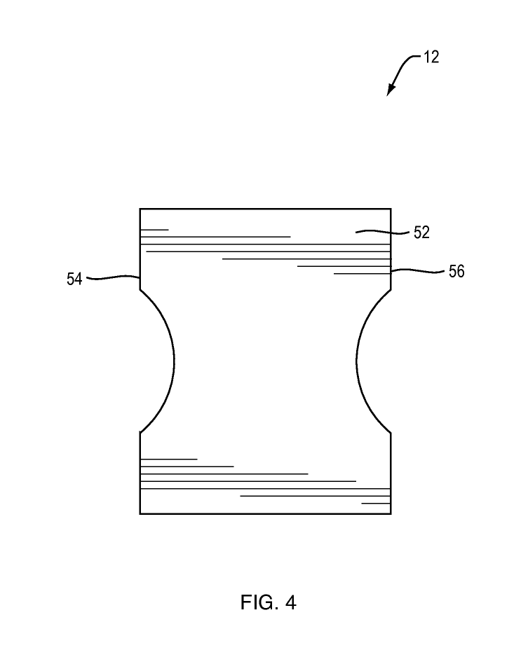

FIG. 4 illustrates yet another exemplary shape of the sides 54, 56 of the mid-portion 52, in which each side 54, 56 is configured as a straight portion with a radial cutout.

The base work platform 12 includes an animal handler positioning area 58 adjacent to at least one side-wall 54, 56 of the mid-portion 52. A side-wall 54, 56 of the mid-portion 52, the first end-portion 60 and the second end-portion 66 may be configured to collectively define the animal handler positioning area 58 (shown as hashed areas in FIG. 1) at which an animal handler may conveniently position him/herself during a handling session. The animal handler positioning area 58 may be located immediately adjacent to the mid-portion 52, and may be formed by one or both of sides 54, 56 of the mid-portion 52.

The animal handler positioning area 58 may have a width W_{G} of about 15 inches to about 70 inches, measured relative to the transverse axis T between the side 54, 56 and the widest portion of the base work platform 12 at which an animal handler can be accommodated during a handling session. In an exemplary embodiment, width W_{M} and width W_{G} are equal. In another exemplary embodiment, width W_{M} is about 1.5× wider than width W_{G}. In yet another exemplary embodiment, width W_{M} is about 2× wider than width W_{G}. In other exemplary embodiments, the ratio between width W_{M} and width W_{G} may vary between about 1 and about 2 in any small increments. In still another exemplary embodiment, width W_{G} is about 1.5× wider than width W_{M}. In another exemplary embodiment, width W_{G} is about 2× wider than width W_{M}. In other exemplary embodiments, the ratio between width W_{G} and width W_{M} may vary anywhere between about 1 and about 2 in any small increments.

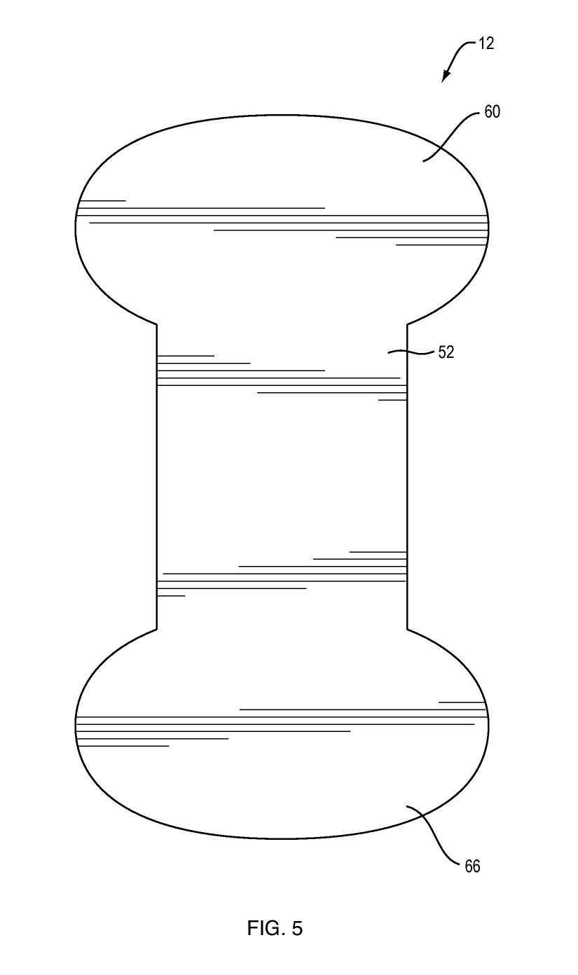

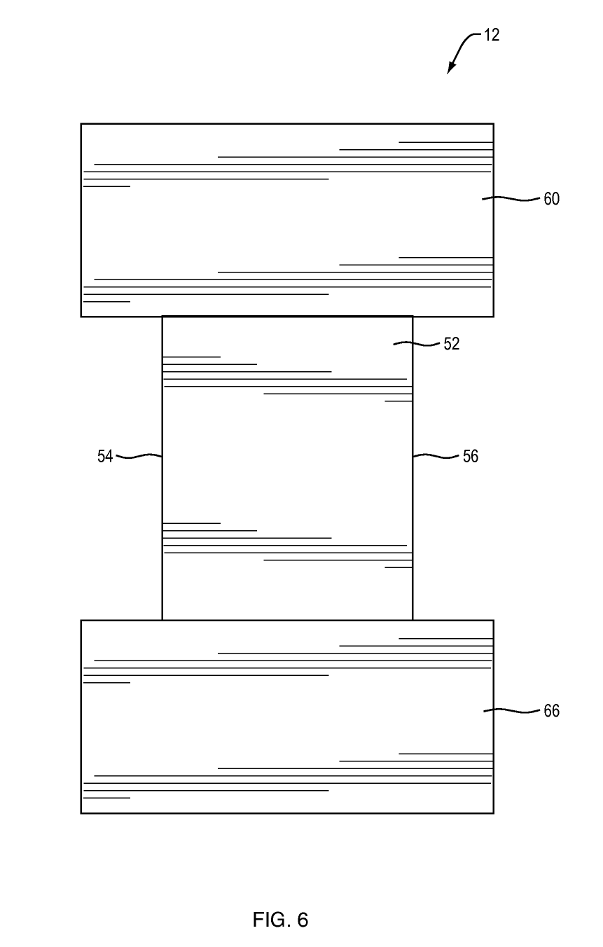

The end-portions 60, 66 of the base work platform 12 may be configured to have various shapes irrespective of the shape of the mid-portion 52. In the exemplary embodiment of FIG. 1 in which the base work platform 12 is in the shape of a dog bone, the end-portions 60, 66 are configured with gibbous shaped portions 62, 64, 68, and 70, in order to give the overall work platform 12 a dog-bone shaped outline. In another exemplary embodiment (as illustrated in FIG. 5), each end-portions 60, 66 is configured to have a partially elliptical shape. In another exemplary embodiment (as illustrated in FIG. 6), each end-portion 60, 66 is configured to have a rectangular shape.

Each end-portion 60, 66 may have a width W_{E} ranging between about 15 inches and about 100 inches at its widest portion, that is wider than the widest width W_{M} of the mid-portion 52. In an exemplary embodiment, width W_{E} is about 2.5× wider than width W_{M}. In another exemplary embodiment, width W_{E} is about 2× wider than width W_{M}. In yet another exemplary embodiment, width W_{E} is about 1.5× wider than width W_{M} In other exemplary embodiments, the ratio between width W_{E} and width W_{M} may vary anywhere between about 1.5 and about 2.5 in any small increments.

The width of the mid-portion 52 relative to the width of one of the end-portions 60, 66 allows the animal handler to conveniently position him/herself at the narrower animal handler positioning area 58 and still access and use the wider end-portions 60, 66, e.g. by placing handling accessories at the end-portions 60, 66. In an exemplary embodiment, the two end-portions 60, 66 may have the same width W_{E} at their widest portions. In another exemplary embodiment, the two end-portions 60, 66 may have different widths W_{E} at their widest portions.

In an exemplary embodiment, the surface area of the planar surface formed by the mid-portion 52 is equal to the surface area of the planar surface formed by either of the end-portions 60, 66. In another exemplary embodiment, the surface area of the planar surface formed by the mid-portion 52 is about 1.5× larger than the surface area of the planar surface formed by either of the end-portions 60, 66. In yet another exemplary embodiment, the surface area of the planar surface formed by the mid-portion 52 is about 2× larger than the surface area of the planar surface formed by either of the end-portions 60, 66. In other exemplary embodiments, the ratio between the surface area of the planar surface formed by the mid-portion 52 and the surface area of the planar surface formed by either of the end-portions 60, 66 may vary anywhere between about 1 and about 2 in any small increments.

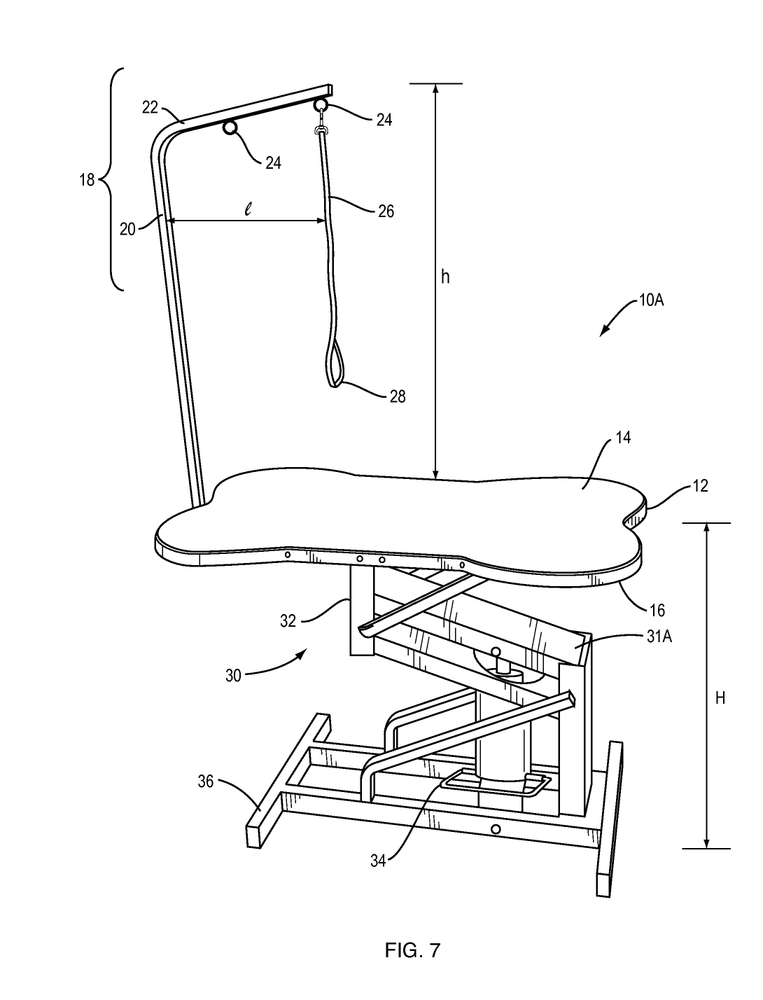

FIG. 7 illustrates a perspective view of an exemplary animal handling station 10A including the exemplary base work platform 12 of FIG. 1. The handling station 10A includes the base work platform 12 for supporting an animal during a handling session. The base work platform 12 may be constructed of any number of materials including, but not limited to, aluminum, stainless steel, wood, wood composite, polymer, and similar materials. The length and width of the base work platform 12 may be selected according to the size of the animal to be supported on the base work platform or the physical location of the platform or both. In an exemplary embodiment, the edges of the base work platform 12 may be raised to prevent dripping of fluid onto the floor or to prevent handling tools and accessories from falling off the base work platform 12.

In an exemplary embodiment, illustrated in FIGS. 1 and 7, the base work platform 12 is designed and configured in a dog-bone shaped outline. This particular shape provides ergonomic, functional, and operational advantages over conventional base work platforms, which tend to be uniformly rectangular, circular or oval. In the exemplary embodiment, an animal handler positioned adjacent to the narrower mid-portion 52 of the dog-bone shaped base work platform 12 is able to position him/herself close to the center of the base work platform 12. This configuration allows the animal handler better control of the animal during a handling session and reduces the risk of the animal handler straining his/her back or suffering another injury while performing a handling function or operation on the animal. This configuration also allows the animal handler to gain better control of the animal. In addition, the slim outline presented by the dog-bone shape compels the animal to reduce its movement and remain centered on the base work platform 12. The slim outline of the dog-bone shaped base work platform 12 thus makes it more ergonomic and convenient to handle the animal and results in a more efficient handling session.

One top surface of the base work platform 12, for example, a surface that contacts the paws of the animal, may be covered with a non-skid surface 14 to reduce the chance of the animal skidding on the base work platform 12 during a handling session. The non-skid surface 14 may be composed of various materials including, but not limited to, rubber, vinyl, polyvinyl chloride (PVC), cloth, and similar materials. In an exemplary embodiment, the non-skid surface 14 may provide a cushioned surface for the animal's comfort during the handling session, allowing the animal to stand on the base work platform 12 for a longer time. The side surfaces or edges of the base work platform 12 may remain uncovered by the non-skid surface 14.

The bottom surface or underside of the base work platform 12 may be equipped with one or more attachment mechanisms 16 configured to hold, hang, or otherwise secure tools and equipment used in handling the animal, e.g., an air blower for supplying a blast of air, a collection pail for collecting the animal's fur, tie-down straps to secure the animal, and similar animal handling equipment. An attachment mechanism 16 may include, but is not limited to, a hook, a sling, and similar engagement mechanisms. In an exemplary embodiment, each underside corner of the base work platform 12 may be equipped with a hook.

The handling station 10A includes a handling arm 18 attached to the base work platform 12 using an attachment device, e.g., clamps, screws, bolts, Velcro, snap-fit mechanisms and the like. The handling arm 18 and its components are provided to secure the animal on top of the base work platform 12 during a handling session. In an exemplary embodiment, the handling arm 18 may be rotatably attached to the base work platform 12 and may be rotated or swung in an arc up to 180°. Once rotated to a desired position, the handling arm 18 may be locked in place and prevented from rotating further using a locking mechanism. In another exemplary embodiment, the handling arm 18 may be fixed and non-movable. In another exemplary embodiment, the handling arm 18 may include two or more vertical arms with a cross-arm that extends across the vertical arms.

In an exemplary embodiment, the handling arm 18 may include a vertical portion 20 and a horizontal portion 22. The vertical and horizontal portions may be separate and attachable to each other or formed in one continuous piece. The height h of the arm 18 may be adjusted to more conveniently secure animals of different sizes, e.g., the height may be increased to secure a taller animal, and decreased to secure a shorter animal. In an exemplary embodiment, the height h may be adjusted between about 15 inches and about 65 inches. The length of the vertical portion 20 of the arm 18 may be adjustable, so that the height h of the arm 18 can be adjusted by adjusting the length of the vertical portion 20. In an exemplary embodiment, the vertical portion 20 may be foldable and/or telescoping, in which the length of the vertical portion 20 may be adjusted by telescoping the vertical portion 20 along its axis.

The length l of the arm 18 may be adjusted to secure an animal at a convenient location on the base work platform 12, e.g., the length may be increased to secure an animal near the mid-portion of the base work platform 12, and may be decreased to secure an animal nearer to the handling arm 18. The length of the horizontal portion 22 of the arm 18 may be adjustable, so that the length l of the arm 18 can be adjusted by adjusting the length of the horizontal portion 22. In an exemplary embodiment, the horizontal portion 22 may be foldable and/or telescoping, in which the length of the horizontal portion 22 may be adjusted by telescoping the horizontal portion 22 along its axis. In an exemplary embodiment, the length l of the arm 18 may be adjusted between about 15 inches and about 100 inches.

The horizontal portion 22 of the handling arm 18 may be equipped with one or more attachment mechanisms 24 disposed along its length. An exemplary attachment mechanism 24 may be a hook. One end of a handling cord 26 may be removably connected to the attachment mechanism 24 using a buckle, a snap, a clasp, and similar attachment mechanisms. The handling cord 26 may be composed of various materials including, but not limited to, nylon, cotton, rubber, and similar materials. The handling cord 26 may be equipped with a length adjustment mechanism, e.g., a plastic slider, that allows the animal handler to adjust the length of the handling cord 26 based on the height of the animal. An exemplary handling cord 26 may range from about 7 inches to about 45 inches in length.

The other end of the handling cord 26 may be connected to a handling loop 28, such that the handling cord 26 and the handling loop 28 hang from the attachment mechanism 24. During a handling session, the head of the animal is positioned through and secured by the handling loop 28. The handling cord 26 may be removably connected to the handling loop 28 using a releasable attachment device including, but not limited to, a buckle, a snap, a clasp, and similar attachment devices. The handling loop 28 may be composed of various materials including, but not limited to, nylon, cotton, rubber, and similar materials. The handling loop 28 may be equipped with a length adjustment mechanism, e.g., a plastic slider, that allows the animal handler to adjust the circumference of the handling loop 28 based on the size of the animal's head. An exemplary handling loop 28 may have a circumference ranging from about 5 inches to about 35 inches.

In an exemplary embodiment, the underside of the base work platform 12 may be rotatably coupled to a base unit 30 that is placed beneath the base work platform 12 to support the base work platform and to optionally lift/lower the base work platform. The base work platform 12 may be allowed to rotate in an arc up to 360° at its connection point with the base unit 30. This ability to rotate the base work platform 12 reduces the need to move around the handling station 10 or reposition the animal on the base work platform 12 during a handling session.

In some exemplary embodiments, the base unit 30 is configured as a lift mechanism 31 with an adjustable height that supports, lifts and lowers the base work platform 12. In some instances, a handling session may begin when the base work platform 12 is lowered by the lift mechanism 31 so that it is a short distance above the ground. The lowering of the base work platform 12 allows an animal to climb onto the base work platform 12 with little assistance and, in some instances, without assistance. Once the animal is secured on the base work platform 12, the lift mechanism 31 is used to elevate the base work platform 12 to a greater height H above the ground. This elevation brings the animal to a work level for the animal handler who may be standing or sitting on a chair. The height to which the base work platform 12 is elevated may be selected based on a number of factors including, but not limited to, the height of the animal, the height of the animal handler, whether the animal is standing or sitting, whether the animal handler is standing or sitting, and similar other factors. The elevated height of the base work platform 12 may be adjusted up or down using the lift mechanism 31 during a handling session and/or between handling sessions. Once elevated to a desired height, the lift mechanism 31 may be locked in place using a locking mechanism. The lift mechanism 31 may optionally be placed on casters (not pictured) to allow the animal handler to easily move the handling station 10A.

The lift mechanism 31 of an exemplary animal handling station may include, but is not limited to, a hydraulic lift, an electric lift, and similar other lift mechanisms. FIG. 7 illustrates an exemplary animal handling station 10A in which the base unit 30 employs a hydraulic lift 31A. The hydraulic lift 31A may be coupled to a link mechanism 32 connected to the base work platform 12 that cooperatively interact to lift and lower the base work platform 12. The hydraulic lift 31A may include a hydraulic pump operable by the animal handler to actuate the link mechanism 32 and thereby raise or lower the base work platform 12. The base unit 30 may include a foot pump 34 with a brake to allow a user to operate the hydraulic pump 31A. The hydraulic lift 31A may be equipped with leveling legs 36 for stability and for securely gripping the base work platform 12.

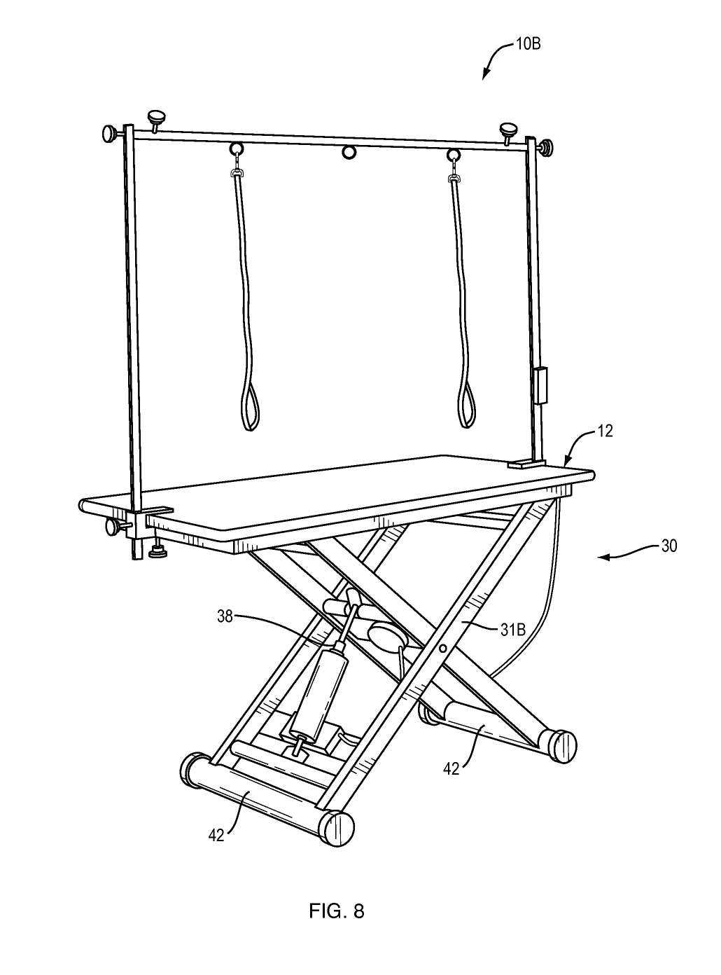

FIG. 8 illustrates another exemplary handling station 10B in which the base unit 30 employs an electric lift 31B. The electric lift 31B may include an electric actuator column 38 connected to the base work platform 12 that lifts and lowers the base work platform 12. The electric lift 31B may include a motor that drives the electric actuator column 38, and a switch operable by the animal handler to turn the motor on or off, e.g., a foot switch 40. The motor may be driven to raise or lower the electric actuator column 38, which then lifts or lowers the base work platform 12. The electric lift 31B may be equipped with leveling legs 42 for stability and for securely gripping the base work platform 12.

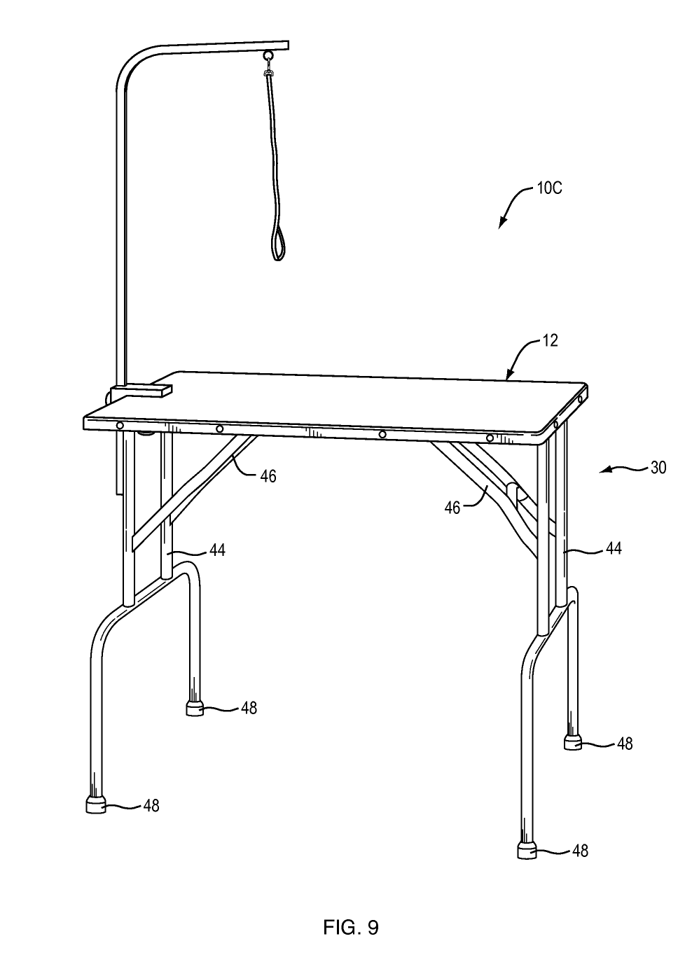

In some exemplary embodiments, the base unit 30 is configured as a stationary support with a fixed height that supports the base work platform 12 but does not adjust the height of the base work platform, e.g., a support column, a set of legs, and similar support structures with a fixed height. FIG. 9 illustrates an exemplary handling station 10C in which the base unit 30 employs a set of folding legs 44. The folding legs 44 support the base work platform 12 during a handling session, but do not allow height adjustment of the base work platform 12. The base unit 30 may also include one or more support brackets 46 for extra stability. The bottom ends of the folding legs 44 may each be fitted with a rubber cap 48 for stability and to securely position the handling station 10C.

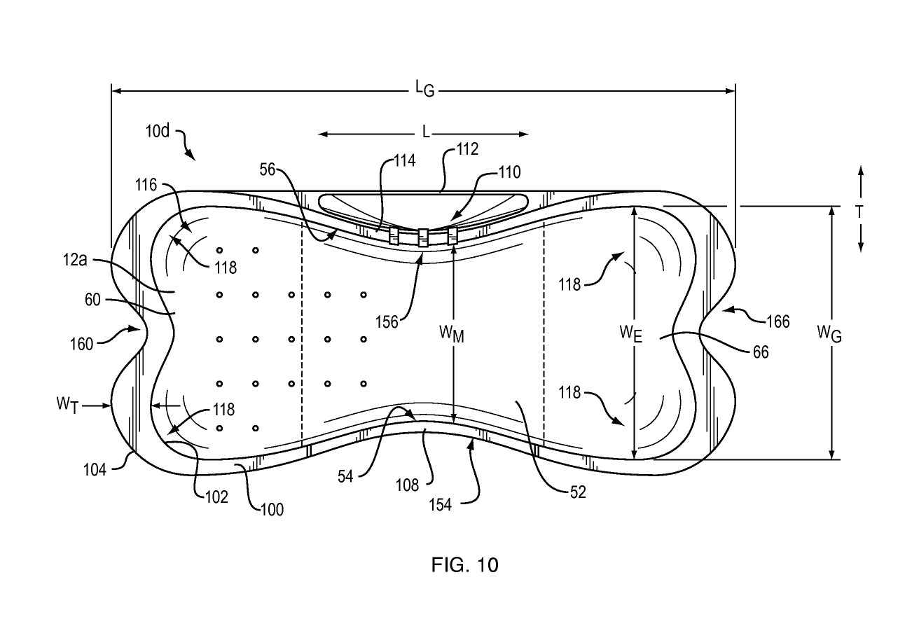

FIG. 10 is a top view of another exemplary embodiment of an animal handling station 10D configured as grooming tub. The animal handling station 10D can include a tub surround wall 100 formed about a perimeter of the base work platform 12a. The base work platform 12a can include the mid-portion 52 with sides 54, 56 and a width W_{M}, as well as the end-portions 60, 66, each having a width W_{E}, as described herein. The tub surround wall 100 can extend generally perpendicularly from the base work platform 12a such that a base work platform forms a bottom or base of the grooming tub and the tub surround wall 100 form sides of the grooming tub. In some embodiments, the tub surround wall 100 can be continuously formed or can be formed in section that are joined to form a water tight wall. In some embodiments, the tub surround wall 100 can be formed integrally with the base work platform 12a. The tub surround wall 100 can have an inner surface 102 and an outer surface 104. A width W_{T} of the tub surround wall 100 can be measured between the inner surface 102 and the outer surface 104. The tub surround wall 100 can be wider at end portions 160, 166 than at the mid-portion 52 of the base work platform 12a. In exemplary embodiments, the width W_{T} of the tub surround wall 100 at the end portions 160, 166 can be wide enough to provide a surface area to support one or more objects, such as tools or accessories for grooming and/or bathing a domesticated animal.

The inner and/or outer surfaces 102, 104 can generally conform to the shape of the perimeter of the base work platform 12a such that the tub surround wall 100 generally has a dog-bone shaped outline, such as the outlines shown in FIGS. 1-6. The tub surround wall 100 can include a first side portion 154 and a second side portion 156, which is opposingly spaced from the first side portion 154. The first side portion 154 of the tub surround wall 100 can extend from the side wall 54 of the base work platform 12a and the second side wall 156 can extend from the side wall 56 of the base work platform 12a . The first side portion 154 can include a door 108 to provide an entrance to and an exit from the grooming tub. In the present exemplary embodiment, the inner and outer surfaces 102, 104 of the first side wall portions 154 and the inner surface 102 of the second side wall portion 156 can be curved to be concave or arched inwardly along the longitudinal axis L toward a center portion of the grooming tub. The outer surface 104 of the second side wall portion 156 can extend generally parallel to the longitudinal axis L. The first end wall portion 160 of the tub surround wall 100 can be formed at the first end-portion 60 of the base work platform 12a and the second end wall portion 166 of the tub surround wall 100, which is opposingly spaced from the first end wall portion 160, can be formed at the second end-portion 66 of the base work platform 12a.

In the present exemplary embodiment, each end wall portion (e.g., wall portions 160, 166) is formed of two contiguous convex portions, e.g., portions that are gibbous shaped (i.e., bulging outwardly away from a center portion of the base work platform). The first end wall portion 160 can be formed of contiguous gibbous shaped portions, and the second end wall portion 166 can be formed of contiguous gibbous shaped portions. The construction and configuration of each side wall portion 154, 156 and end wall portion 160, 166 with two gibbous shaped portions gives the overall grooming tub a dog-bone shaped outline.

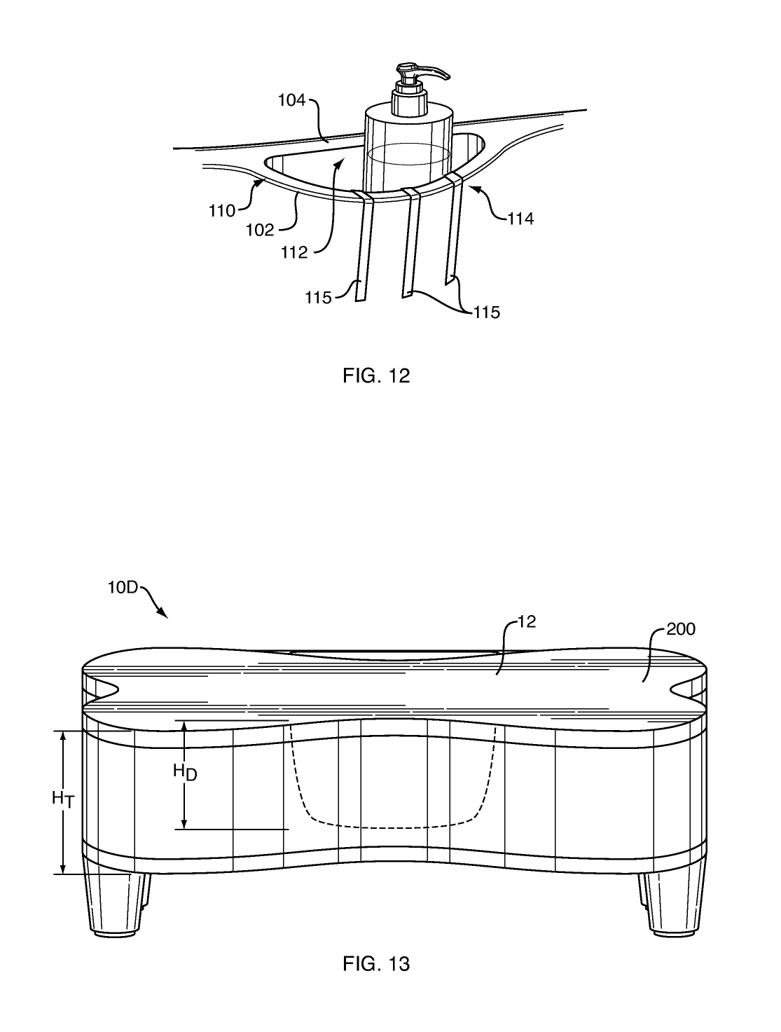

Referring to FIGS. 10 and 12, in exemplary embodiments, a bin 110 can be formed between the inner and outer surfaces 102, 104. For example, in the present embodiment, the bin 110 can be formed in the side wall 156. The bin 110 can be integrally molded or otherwise formed in a wall of the tub. The bin 110 can provide an area in the mid-portion 52 of the base work platform 12a for holding grooming and/or bathing tools and/or accessories, such as, for example, shampoo, conditioner, soap, scissors, and/or other objects. The bin 110 can generally conform to the shape of the inner and outer surfaces 102, 104 of the side wall 156, such that a back wall 112 of the bin 110 extends generally parallel to the longitudinal axis L, and a front wall 114 of the bin 110 is curved to be concave or arched inwardly along the longitudinal axis L towards a center portion of the base work platform 12a. In exemplary embodiments, the front wall 114 of the bin 110 can include slots or channels 115 so that an interior of the bin 110 can be in communication with an interior area 116 (e.g., a tub cavity) of the grooming tub to allow the bin 110 to drain into the interior area 116 of the grooming tub.

Referring to FIG. 10, the inner surface 102 of the tub surround wall 100 and the top (work) surface of the base work platform 12a can define the interior tub area 116 for bathing and/or grooming an animal. In exemplary embodiments, the interior area 116 can be an undivided contiguous space or can be divided or segmented into separate spaces. A length L_{G} of the interior area 116 can be measured along the longitudinal axis L between the inner surface 102 of the first and second end wall portions 160, 166, and the width W_{G} of the interior area 116 can be measured along the transverse axis T between the inner surface 102 of the first and second side wall portions 154, 156 of the tub surround wall 100. The length and widths of the interior area 116 of the grooming tub can be defined by the length and width of the base work platform 12a as described above. The configuration of the first and second end portions 160, 166 can form cove areas 118 in the grooming tub that are generally separate from the main handling and/or bathing portion of the grooming tub generally defined by the width of the mid-portion 52 and the length of the base work platform 12a. The cove areas 118 can provide an area within the interior area 116 of the grooming tub to place grooming and/or bathing instruments and/or accessories in the grooming tub without interfering with an animal handling session. In some embodiments the bottom or base of the cove areas 118 can be coplanar with the remainder of the work surface. In some embodiments, the cove areas 118 can be vertically offset from the remainder of the work surface. For example, in some embodiments, the cove areas can form a deeper portion of the grooming tub 10D or a shallower portion of the grooming tub 10D.

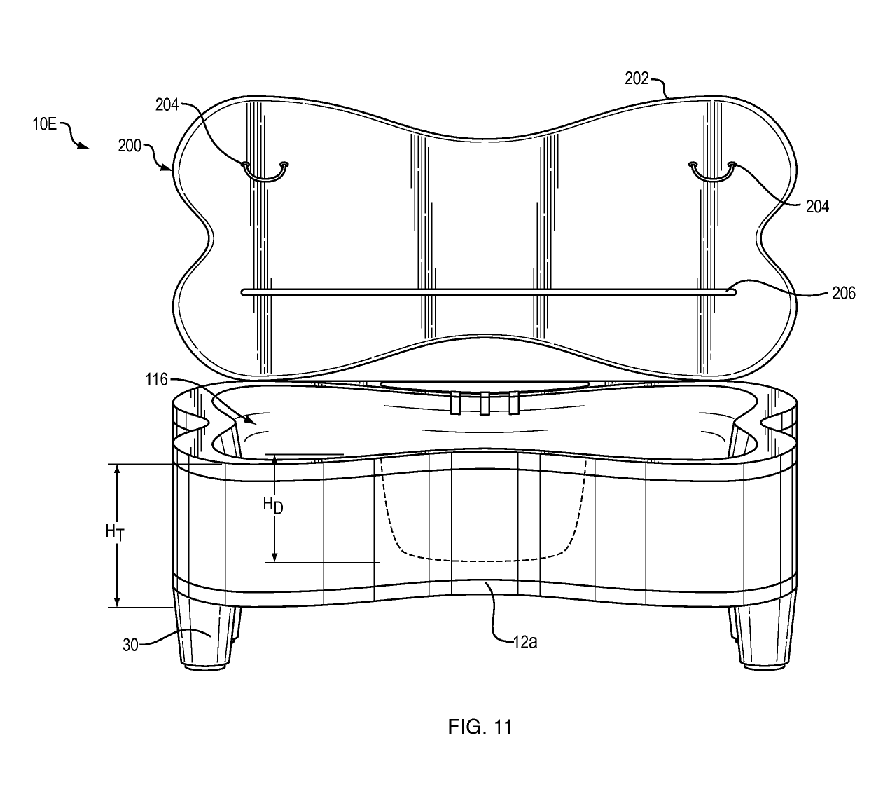

FIG. 11 illustrates a front perspective view of the exemplary animal handling station 10E that includes the base work platform 12a, the base unit 30, the tub surround wall 100, and a back splash 200. The base unit 30 can be integrally formed with the grooming tub and/or can be removably attached to the grooming tub. The tub surround wall 100 can have a height H_{T} that can be measured perpendicularly from the work surface of the base work platform 12a. The door 108 formed in the first side portion 154 can be removably or otherwise mounted with respect to the first side portion 154. In the present embodiment, the door 108 can have a height H_{D} that is less than the height H_{T} such that the door 108 does not extend over the entire height H_{T} and only extends over a portion of the first side wall 154. For example, the door 108 can extend downwardly from a top end of the tub surround wall 100 towards a bottom end of the tub surround wall 100, but terminate before reaching the bottom end of the tub surround wall 100.

The back splash 200 can be disposed between the first and second ends 160, 166 of the grooming tub along the outer surface 104 of the second wall portion 156. In the present embodiment, the back splash 200 can mirror the outline of the interior area 116 of the grooming tub defined by the inner surface 104 of the grooming tub, such that the back splash 200 has a generally dog-boned shape perimeter 202. The back splash 200 can be attached to the tub surround wall 100 of the grooming tub at each end such that there are two locations at which contact between the tub surround wall 100 and the back splash 200 can be made. The back splash 200 can include hooks 204 and a bar 206 to which an animal in the grooming tub can be tethered to aid in restraining the animal's movement while being groomed and/or bathed and/or for holding one or more objects, such as, for example, towels.

In some embodiments, the back splash 200 can be fixedly positioned with respect to the tub surround wall 100 such that the position of the back splash 200 relative to the tub surround wall 100 cannot be changed. In some embodiments, the back splash 200 can be attached to the tub surround wall 100 using one or more lockable hinges so that the back splash 200 can move between an upright open position (FIG. 11), and a horizontal closed position (FIG. 13). For embodiments in which the back splash 200 is rotatably attached to the tub surround wall 100, the back splash 200 can be selectively locked in the upright position to prevent the back splash from rotating to the horizontal position and closing on an animal handler and/or animal. When the back splash is in the horizontal closed position (FIG. 13), the backsplash can form the base work platform 12a such that the animal handling station 10E can be configured as a grooming tub and/or a grooming table.

In exemplary embodiments, the animal handling station 10E can be formed of molded plastic, aluminum, stainless steel, and/or any other material suitable to be used in wet environments. In the present embodiment, the base work platform 12a and the tub surround wall 100 can be formed of plastic and the back splash can be formed of stainless steel.

One of ordinary skill in the art will appreciate that the present invention is not limited to the specific exemplary embodiments described herein. Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are to be read as including what they set forth literally and also those equivalent elements which are insubstantially different, even though not identical in other respects to what is shown and described in the above illustrations.

What is claimed is:

1. An animal grooming tub comprising:
a base work platform forming a closed end of the grooming tub and defining a work surface; and
a wall extending perpendicularly from a perimeter of the base work platform to define an open end, the including a first end wall portion, a second end wall, and two opposing middle wall portions,
an inner surface of the wall and the work surface of the base work platform defining an interior tub area having a first end, a second end, and a middle portion,
the first end of the interior tub area being defined by the first end wall portion and having a first width (W1),
the second end of the interior tub area being defined by the second end wall portion and having a second width (W2),
the middle portion of the interior tub area being defined by the two opposing middle wall portions and having a third width (W3); and
an animal handler area is formed by the first end wall portion, the second end wall portion and a first one of the two opposing middle wall portions, the animal handler area being defined by a W₃:W₁ ratio of about 1:2 and a W₃:W₂ ratio of about 1:2 to allow an animal handler to be adjacent to an animal disposed within the interior area.

2. The animal grooming tub of claim 1, wherein the first one of the two opposing middle wall portions is concave in shape.

3. The animal grooming tub of claim 1, wherein the first end wall portion includes a first convex portion and a second convex portion, the first and second convex portions disposed contiguous to each other.

4. The animal grooming tub of claim 1, wherein a length of the first one of the two opposing middle wall portions measured along a longitudinal axis of the animal grooming tub defines a length of animal handler area and the first and second end wall portions define out coves that are adjacent to the animal handler area.

5. The animal grooming tub of claim 1, wherein a door is formed in the first one of the two opposing middle wall portions.

6. The animal grooming tub of claim 5, wherein the door is concave in shape.

7. The animal grooming tub of claim 1, wherein a bin is formed in a second one of the two opposing middle wall portions between the inner surface and an outer surface of the wall, an interior bin area conforming to the inner and outer surfaces.

8. The animal grooming tub of claim 7, wherein a front wall of the bin includes channels to facilitate communication between the interior bin area and the interior tub area.

9. The animal grooming tub of claim 1, wherein a width of the first end wall and second end wall portions is wider than each of the two opposing middle wall portions.

10. The animal grooming tub of claim 1, further comprising a back splash coupled to wall, the back splash including at least one animal retaining structure.

11. An animal grooming tub comprising:
a base work platform forming a bottom of the grooming tub;
a wall extending from a perimeter of the base work platform, the wall having a first side wall portion, a second side wall portion, a first end wall portion, and a second end wall portion, the first side wall portion being opposingly spaced from the second side wall portion, the first end wall portion being opposingly spaced from the second end wall portion,
the wall and the base work platform defining an interior area of the grooming tub;
an animal handler area defined by a width of the interior area between the first and second side wall portions and a length of the interior area between the first and second end wall portions; and
at least one cove area is defined at the first end wall portion, the cove defined by an area outside of and adjacent to the animal handler area,
wherein the base work platform and the wall have a dog-bone shaped outline.

12. The animal grooming tub of claim 11, further comprising a base integrally formed with the base work platform to support the base work platform.

13. The animal grooming tub of claim 11, further comprising a back splash disposed along the second side wall portion, the back splash including at least one animal tethering component.

14. The animal grooming tub of claim 13, wherein the back splash is rotatably coupled to the wall, the back splash configured to rotate between a vertical position in which the interior tub area is accessible and a horizontal position in which the interior tub area is inaccessible, the grooming tub being useable as a grooming tub when the back splash is in the vertical position and being useable as a grooming table when the backsplash is in the horizontal position.

15. The animal grooming tub of claim 11, wherein the first end portion of the base work platform has a first width (W₁), the second end portion of the base work platform has a second width (W₂); and the middle portion of the base work platform has a third width (W₃) disposed contiguously between the first and second end portions to form a planar surface, and
wherein the first side of the middle portion, the first end portion and the second end portion collectively define an animal handler area, the animal handler area being defined by a W₃:W₁ ratio of about 1:2 and a W₃:W₂ ratio of about 1:2 to allow an animal handler to be adjacent to an animal supported on the base work platform.

16. The animal grooming tub of claim 11, wherein a bin is formed in the second side wall portion between the inner surface and an outer surface of the wall, an interior bin area conforming to the inner and outer surfaces.

17. The animal grooming tub of claim 17, wherein a front wall of the bin includes channels to facilitate communication between the interior bin area and the interior tub area.

18. The animal grooming tub of claim 11, wherein a door is formed in the first side wall portion.
